(19) United States
(12) Patent Application Publication
(10) Pub. No.: US 2005/0186945 A1
(43) Pub. Date: Aug. 25, 2005

(54) System and method for enabling a wireless terminal to interact with a voice mail system via a data communications network

(76) Inventor: Gadi Mazor, Ramat Efal (IL)

Correspondence Address: PILLSBURY WINTHROP SHAW PITTMAN, LLP, P.O. BOX 10500, MCLEAN, VA, 22102, US

(21) Appl. No.: 11/030,894

(22) Filed: Jan. 10, 2005

Related U.S. Application Data
(60) Provisional application No. 60/534,965, filed on Jan. 9, 2004.

(51) Int. Cl. H04M 1/64; H04M 11/10

(52) U.S. Cl. 455/413; 455/412.1; 379/88.22

(57) ABSTRACT

One aspect of the invention relates to a telephonic interface between a data communications network and an enterprise voice mail system. This interface may enable access to voice data and the transmission of voice data to a wireless terminal device such as a text-based wireless terminal device. The interface may enable a user to periodically check for voice messages, retrieve voice messages, delete voice messages, forward voice messages, or perform other actions.

### CROSS REFERENCE TO RELATED APPLICATIONS

This application claims priority to U.S. Provisional Patent Application Ser. No. 60/534,965, filed Jan. 9, 2004, which is incorporated herein by reference in its entirety.

### FIELD OF THE INVENTION

The invention relates to a system and method for enabling a wireless terminal device operating in a data communications network to interact with a voice mail system.

### BACKGROUND OF THE INVENTION

Voice mail systems, in general, are well known. Typically, a user may use a telephone to call a voice mail system over a voice network and access a personal voice mailbox. The user may then determine if any new messages exist in the voice mail system and interact with the voice mailbox to perform other known functions. For example, the user may listen to, delete, save, forward, reply to, or otherwise interact with voice mails. Other voice mail system functions may be performed, such as, recording or changing an outgoing message, choosing which of a number of stored messages should be used as an outgoing message, changing answering options, or changing mailbox options.

While voice mail provides many known advantages, various limitations and problems exist. One example is the fact that a user typically must initiate an interaction by calling the voice mail system to determine whether any new voice messages have been received. If no new voice messages have been received, the user has wasted time and has incurred the cost of the telephone call. When traveling internationally, it can be very expensive to check voice mail. If a user checks the voice mail system and has no voice messages, significant wasted costs are incurred. If messages exist or are not urgent, it may be unnecessarily expensive to listen to the messages. If a user has an urgent message and fails to check voice mail, the user may not get the information in a timely fashion. If the user has a large number of messages, it may be time consuming and expensive to listen to each voice message.

Another problem is that many people have more than one voice mailbox. In some cases, people have a voice mailbox for their office or work number, one or more voice mailboxes for a mobile telephone and perhaps other voice mailboxes. Having a large number of voice mailboxes compounds the problem because it requires the user to periodically check multiple voice mailboxes for new messages.

For users that check voice mail by mobile telephone, other problems exist. For example, the user must be able to connect to and maintain a connection with a cellular phone system to access a voice mail system. If the user is in an area where no or poor mobile phone coverage exists, it may be impossible or difficult to check voice mails. If the user is placing the telephone call in an area where roaming, international or other charges apply, this too can be expensive.

Other limitations and problems exist with existing voice mail systems.

Wireless terminal devices in general are well known. In recent years, text-based wireless terminal devices have become extremely popular. Such devices include mobile phones having Short Message Service (SMS) text messaging, personal digital assistants (PDAs) with wireless messaging capabilities, mobile phone/PDA combos, two-way pagers, and other wireless terminal devices. Various networks are known for enabling data communications to and from wireless terminal devices. Differences between telephone (or voice) communications networks and data communications networks are well known. In some instances, a device may be capable of separately accessing both types of networks. In other words, the same device may be configured to dial into a telephone communications network using a first protocol and access a data network, such as the Internet, using a second protocol.

One popular device, known as the Blackberry, is offered by Research in Motion. This device operates in connection with a Blackberry enterprise server, which communicates with an email server to “push” text-based items (e.g., emails and calendar items) to the user's Blackberry device over a data network in a known manner. Furthermore, users may use the Blackberry to separately place a call to a telephone communications network utilizing a telephone communications protocol. To date, the push technology has been used to access information that originates in data networks rather than accessing information that originates in telephone communication networks. For example, push technology has been used to disseminate email, calendar entries and other text-based items. Push technology has not been used to access voice mail systems, which requires access via a voice-based telephone network. These and other drawbacks exist.

### SUMMARY OF THE INVENTION

The invention overcoming these and other drawbacks of existing systems relates to a system and method for interacting with voice mail systems via a data communications network. In one embodiment, the invention enables interaction between a data communications network and an unassociated voice mail system. The data communications network may have its own telephone or voice mail system integrated or associated with it. However, the voice mail system to which the interaction of this embodiment is directed may be separate from, or otherwise unassociated with the data communications network. For example, the invention may enable a user within a data communications network operated by one organization to retrieve messages or otherwise interact with a voice mail system operated by another organization. In some embodiments, the voice mail system may include an enterprise voice mail system. An enterprise voicemail system may include a voice mail system that is organized and maintained for a particular organization, business, or other entity. In other embodiments, the voice mail system to which the interaction of the invention is directed may include a personal or residential voice mail system.

One aspect of the invention relates to a system and method for determining whether users have any new voice mail messages in a voice mail system on a telephone communications network. Another aspect of the invention relates to communicating information regarding the results of the determination using a wireless terminal device via a data communication network. The determination may be system initiated, user initiated, or otherwise initiated. Based on the information communicated to users, users may utilize the wireless terminal device to interact with voice mail messages or otherwise interact with the voice mail system via the data communication network.

According to one embodiment, the system may interact with the voice mail system and/or may interact with individual voice mail messages. For example, at predetermined times or upon the occurrence of predetermined events, a call server associated with the system may telephonically call a user's voice mailbox, simulate keying in the user's mailbox password, listen to any messages, record or convert all or some of the voice messages to text, navigate the voice messages and notify users of the existence or non-existence of message(s), receive instructions from users, and/or act on the voice messages according to the user's instructions. This may enable users to have mobile, centralized, access to numerous telephonic voice mail systems, regardless of the age of the voice mail systems (e.g., legacy systems), the manufacturer of the voice mail systems, or the administrator of the voice mail systems. This centralized access may reduce the cost, time consumption, and inefficiency associated with typical access portals for voice mail systems.

According to one embodiment, a determination of whether users have new voice mail messages may be initiated by the system of the invention. The system may determine whether users have new messages in any one or more of a variety of ways. For example, the system may determine whether new messages exist in a given voice mail system at predetermined times, based on the occurrence of certain events, or based on a user initiated request.

According to one embodiment of the invention, the call server may determine whether new voice mail messages exist by calling a voice mailbox, keying in a password for the mailbox, and recording or interpreting an opening message. The system may then automatically recognize whether the mailbox stated that “you have no new messages” (or equivalent indication), “you have X new messages” (or equivalent indication, where X is the number of new voice messages), “you have X new messages and Y old messages,” or other recorded message or indication. The system may then notify users of the existence or absence of messages via a text message, voice message, or otherwise.

Users may then select one or more voice messages to listen to and the system may either connect users with a voice mailbox, or collect the selected voice messages electronically. In one embodiment, the system may connect users to the voice mailbox by placing a call to the voicemail system, placing a second call to (or otherwise establishing a connection with) the wireless terminal device (or any other phone the user directs it to call), and bridging the two calls. In some embodiments, the order of the calls may be varied. The differences in communication protocols between the data communications network upon which the wireless terminal device resides (data communications protocol) and the telephone network upon which the voicemail system resides (telephone communications protocol) may be bridged by the system (e.g., the call server or other element of the system). In one embodiment, this bridging may be accomplished by inputting instructions into the voice mail system as telephone-communications-protocol-based signals such as, for example, Dual Tone Multi-Frequency (DTMF). This bridging may also be accomplished by translating and/or converting the voice-formatted (or otherwise formatted) responses received from the voice mail system into a format that may be recognized, read, transmitted, and/or displayed on a wireless terminal device (e.g., a data-communications-friendly format). In another embodiment, instead of bridging two phone calls (or other communications), the call server may call the voice mail system and retrieve or “scrape” one or more messages and/or information regarding one or more messages residing in a mailbox according to user instructions. These messages and/or information may then be stored and/or transmitted to a wireless terminal device.

In some embodiments, the system may enable users to navigate voice message menus. The system may also record one or more voice messages, compress them, and retrieve them to a user's text-based wireless terminal device. Users may perform message communication associated functions such as, for example, deleting, saving, replying, and/or forwarding, the voice messages, among other functions.

In one embodiment, the invention may include features and functions for enabling users to send action commands from the wireless terminal device. An action command may include a command that performs message communications associated functions such as, for example, deleting, saving, replying, or forwarding voice messages. Action commands may also include commands that perform other functions. In one embodiment of the invention, action commands may be executed using Dual Tone Multi-Frequency (DTMF) signals, among other signals. For example, if a user is alerted to the existence of a message in a voice mailbox and decides to delete the message, an action command may be sent from a wireless terminal device to a call server (or other element of the system of the invention). The call server may then call the voice mailbox, navigate the voice message menus, and execute the command for erasing the message using DTMF signals or other signals.

Notifications to users communicating information regarding a given voice mail system may include text messages that are sent to wireless terminal devices over a data communications network. These notifications may convey information such as, for example, the existence of one or more new messages, the absence of new messages, a textual description of some or all of the meta-data regarding the content of the message(s) in the voice mail system (described in detail below), and/or a voice file (e.g., a compressed voice file) of part or all of one or more of the messages (and combinations thereof) in the voice mail system.

Users may interact with a given voice mail system by the use of wireless terminal devices through which notifications are received, instructions are sent, or other interactions occur. If a user issues instructions from the wireless terminal device, the instructions may be sent to a server on the system of the invention as a text message from the wireless terminal device. For example, the instructions maybe sent as an e-mail to a particular e-mail address, where the email address may be resolved at the server to perform a particular function. Instructions may also be sent via other data protocols such as, for example, an HTTP connection. Additionally or alternatively, instruction information may be included within such a text message. The server may receive and process instruction information, interact with a voice mail system via a telephone communications protocol to obtain any necessary data therefrom, and pass the data back to the user.

User profiles or other information may be stored at the server to associate the “from” address of the text message, or an available address of the device it is received from, with the user. The information may include information regarding the user's voice mailbox, including any extension, password or other information necessary or desirable to implement the features and functions described herein.

A call server (or other element of the system of the invention) may enable interaction with individual messages by executing commands such as listen, delete, forward, reply, save and/or provide other commands for voice messages stored in a voice mailbox. Additionally, the server may perform other voice mail system operations (e.g., mailbox options, greetings, and other system operations).

In one embodiment, the invention may include features and functions for accessing voice messages, translating the voice messages to textual messages, and transmitting the textual messages to a text-based wireless terminal device. In yet another embodiment of the invention, the translated messages may be displayed on a text-based wireless terminal device for a user.

One aspect of the invention relates to features and functions for creating meta-data associated with voice messages in a voice mailbox. When a new voice message is recognized in the voice mailbox, the invention may extract meta-data, such as who or what extension or number the message is sent from, the time the message was received, the length of the message, the status of the message (e.g., urgent, normal or low priority) or other meta-data.

Another aspect of the invention relates to features and functions for creating identification indicia (e.g., alphanumeric identification numbers) that identify voice messages in a voice mailbox. In one embodiment of the invention, the identification indicia may include or otherwise be linked to meta-data such as, for example, data associated with a voice stamp of a predetermined portion of the voice message (e.g., data associated with a voice stamp of the first few seconds of the voice message), caller ID, length of the message, date of receipt of the message, time of receipt of the message, and/or other meta-data. In some embodiments, the meta-data and the identification indicia for the voice message may be sent to the user. If the user has more than one voice message in their voice mailbox, the identification indicia may be used to select a message with which the user desires to interact. In some embodiments, the identification indicia and/or the meta-data may be utilized by the system of the invention to create an index of one or more messages that exist in the voice mailbox.

Another aspect of the invention relates to a system and method for synchronizing voice messages between a voice mailbox and a text-based wireless terminal device using identification indicia for the voice message.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an exemplary architecture of a system for interacting with a voice mailbox and a text-based wireless terminal device, according to an embodiment of the invention.

FIG. 2A illustrates an exemplary system including modules for processing voice messages stored in a voice mailbox, according to an embodiment of the invention.

FIG. 2B illustrates an exemplary system including modules for processing voice messages stored in a voice mailbox, according to an embodiment of the invention.

FIG. 2C illustrates an exemplary system including modules for processing voice messages stored in a voice mailbox, according to an embodiment of the invention.

FIG. 3A illustrates an exemplary process of accessing voice messages stored in a voice mailbox using a text-based wireless terminal device, according to an embodiment of the invention.

FIG. 3B illustrates an exemplary process of interacting with voice messages stored in a voice mailbox using a text-based wireless terminal device, according to an embodiment of the invention.

FIG. 3C illustrates an exemplary process of interacting with voice messages stored in a voice mailbox using a text-based wireless terminal device, according to an embodiment of the invention.

FIG. 4 illustrates an exemplary process of synchronizing messages between a voice mailbox and a data communications network, according to an embodiment of the invention.

### DETAILED DESCRIPTION OF THE INVENTION

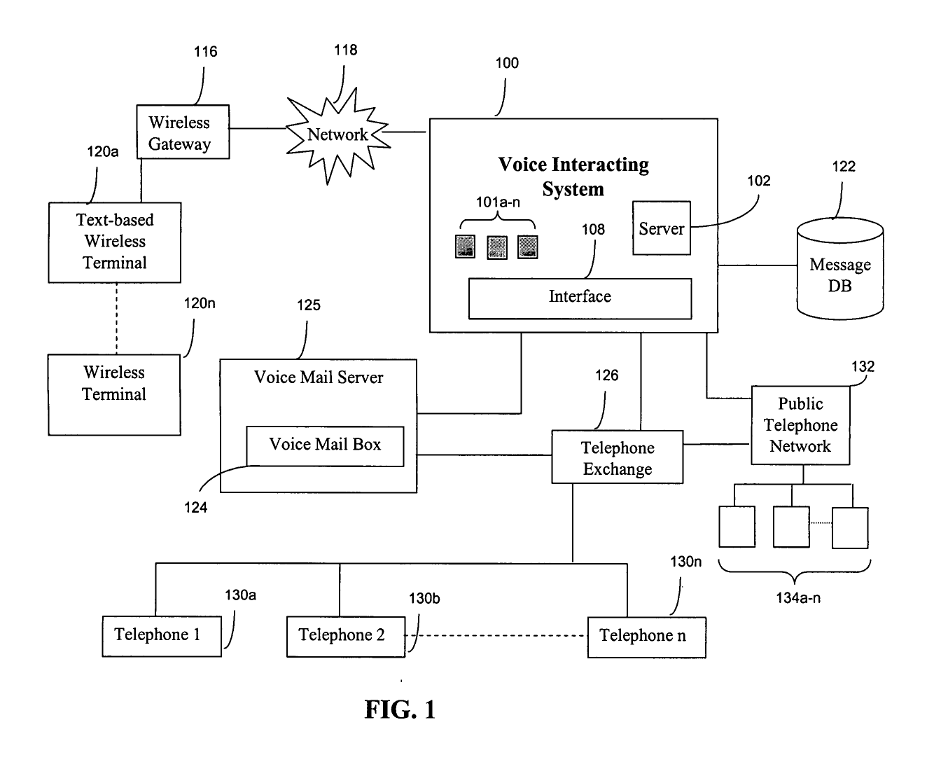

The invention provides a system and method for enabling a wireless terminal device operating in a data communications network to interact with a voice mail system. In one embodiment, the invention enables interaction between a data communications network and an unassociated voice mail system. The data communications network may have its own telephone or voice mail system integrated or associated with it. However, the voice mail system to which the interaction of this embodiment is directed may be separate from, or otherwise unassociated with the data communications network. For example, the invention may enable a user within a data communications network operated by one organization to retrieve messages or otherwise interact with a separate voice mail system operated by another organization. In some embodiments, the voice mail system may include an enterprise voice mail system. An enterprise voicemail system may include a voice mail system that is organized and maintained for a particular organization, business, or other entity. In other embodiments, the voice mail system may include a personal or residential voice mail system. FIG. 1 is an exemplary illustration of a system for interacting with voice mail system via a data communications network. The system may enable communication/interaction using data network protocols and telephone communications network protocols.

The system of FIG. 1 may include a voice interacting system 100 for accessing and processing voice messages that reside in a telephone communications network using wireless terminal devices 120a-n. Voice interacting system 100, one or more wireless terminal devices, and or other elements may comprise a data communications network that operates using data communications protocols (or data network protocols). Wireless terminal devices 120a-n may include, for example, mobile phones with SMS text messaging, PDAs, mobile phone/PDA combos, two-way pagers, laptops, or other text-based wireless terminal devices. Wireless terminal devices 120a-n may have integrated telephone and voice mail capabilities, and such capabilities may be enabled via integrated telephone and/or voice mail systems associated with wireless terminal devices 120a-n and/or the data communications network. However, the interaction/communication to which voice interacting system 100 is directed may, in some embodiments, involve an unassociated voice mail system, separate from any integrated telephone/voice capabilities or systems.

In one embodiment, voice interacting system 100 may include a call server 102, additional servers, computers, or other computer-implemented elements enabling performance of the functions described herein. In one embodiment, voice interacting system 100 may send and/or receive commands originating from data network protocols to and from elements of the data communications network. Voice interacting system 100 may also perform actions using telephone communications network protocols.

Voice interacting system 100 may be coupled to a voice mail system that may include various elements such as, for example, a mail server 125, a voice mailbox 124 (e.g., private branch exchange (PBX) voice mailbox), or other elements. In some embodiments, the voice mail system may include an enterprise voice mail system that is not part of the data communications network on which voice interacting system 100 or wireless devices 120a-n operate. Voice mail server 125 may be operatively connected to or interact with a telephone exchange 126 (e.g., a PBX). Telephone exchange 126 may be operatively connected to or interact with one or more wired and or wireless enterprise telephones (130a-n). Telephone exchange 126 may also be connected to a public telephone network 132 on which one or more external telephones 134a-n reside. The connection of telephone exchange 126 to both telephones 130a-n and public telephone network 132 may enable voice mail server 125 to receive calls/messages from both internal sources and the outside world. In some embodiments, voice interacting system 100 may connect to the voice mail system (e.g., voice mail server 125) through public telephone network 132.

Voice mailbox 124 may be one of many voice mailboxes on the voice mail system. Voice mailbox 124 may store one or more voice messages received from one or more telephones (130a-n), external telephones 134a-n, or other communication devices. Voice interacting system 100 may access, retrieve, and/or store one or more of the voice messages stored in voice mailbox 124 using telephone communications network protocols or other protocols, conversion, compression or translation software, and/or other elements. In one embodiment of the invention, a telephone communications network upon which the voice mail system operates may be implemented using analog and/or digital communications.

Voice interacting system 100 may include an interface 108 for interacting with voice server 125. Interface 108 may enable voice interacting system 100 to interact with voice mailbox 124. In one embodiment, Interface 108 may interface with the voice mail system via a telephonic connection (e.g., over a telephone communications protocol). In another embodiment, Interface 108 may interface with the voice mail system via application program interfaces (APIs). These APIs may be published by the vendor/manufacturer who developed the voice mail system. The interactions facilitated by interface 108 may include, for example, accessing and retrieving, and/or storing one or more voice messages stored in voice mailbox 124. Other interactions may occur. Voice interacting system 100 may then transmit the voice messages from the voice mailbox 124 to wireless terminal devices 120a-n or other devices.

In one embodiment of the invention, voice interacting system 100 may access one or more of the voice messages of voice mailbox 124 via telephone exchange 126. In another embodiment of the invention, voice interacting system 100 may be coupled to a message database 122. Message database 122 may include any data storage device and may be used to store one or more voice messages retrieved from voice mailbox 124. In one embodiment, message database 122 may store one or more retrieved voice messages in a voice format, text format, and/or other formats.

Voice interacting system 100 may process one or more retrieved voice messages according to a user's commands and transmit the processed messages: to wireless terminal devices 120a-n via wireless and/or wired gateway 116. As used herein, a “user” may include a person, a group of people, an organization, or other entities or groups thereof. Voice interacting system 100 may also transmit the processed messages to wireless terminal devices 120a-n via a network 118. Network 118 may include the Internet, an intranet, a PAN (Personal Area Network), a LAN (Local Area Network), a WAN (Wide Area Network), a SAN (Storage Area Network), or a MAN (Metropolitan Area Network), a wireless device compatible network, or other forms of networks that would be apparent to one skilled in the art. For the features of the invention described herein, the data connections between wireless terminal devices 120a-n and the data communications network (e.g., with voice interacting system 100) may be synchronous (having a direct connection such as, for example, HTTP) or may be accomplished by sending commands/data back and forth asynchronously (such as, for example, e-mail or SMS).

Voice interacting system 100 may include and/or communicate with one or more modules 101a-n for accessing, retrieving, processing and/or transmitting one or more voice messages, among other functions. In one embodiment of the invention, the voice messages may be transmitted to the corresponding wireless terminal device 120 using a digital network protocol.

Those having skill in the art will appreciate that the invention described herein may work with various system configurations. Accordingly, more or less of the aforementioned system components may be used and/or combined in various embodiments. It should also be understood that various software modules described herein that are utilized to accomplish the functionalities described herein may be maintained on one or more components of the system of FIG. 1, as necessary. In other embodiments, as would be appreciated, the functionalities described herein may be implemented in various combinations of hardware and/or firmware, in addition to, or instead of, software.

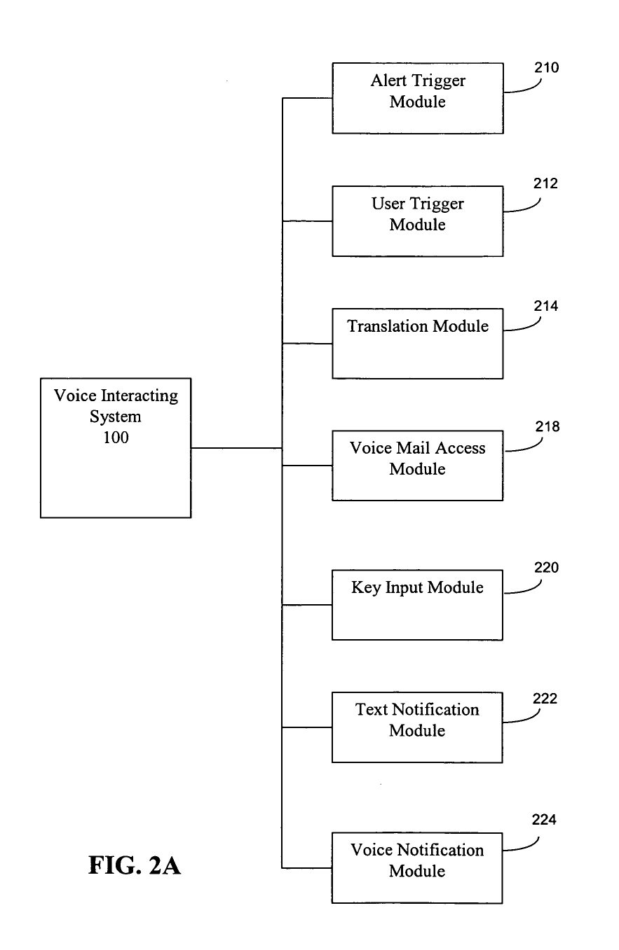

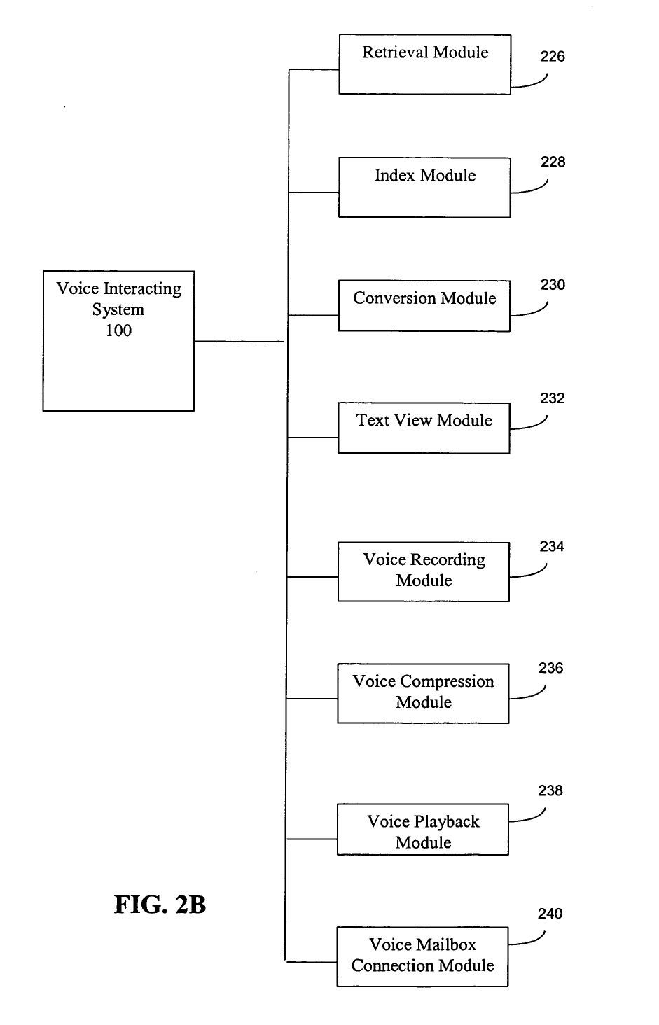

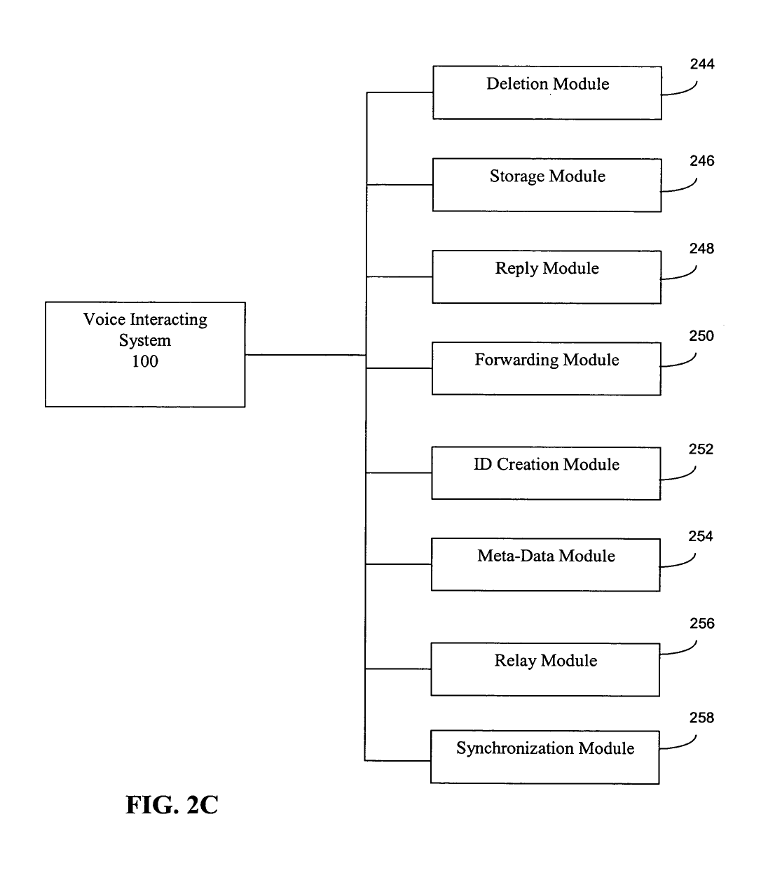

As illustrated in FIG. 2A, voice interacting system 100 may include, or communicate with one or more modules (similar to or the same as modules 101a-n illustrated in FIG. 1). The one or more modules may include, for example, an alert trigger module 210, a user trigger module 212, a translation module 214, a voice mail access module 218, a key input module 220, a text notification module 222, a voice notification module 224, and/or other modules.

Alert trigger module 210 may trigger voice interacting system 100 to check for voice messages in voice mailbox 124 upon the occurrence of an event and/or at one or more predetermined time intervals. In one embodiment, an event upon which alert trigger module 210 may check for voice messages includes recognition that one or more voice messages have been received by voice mailbox 124. In another embodiment, alert trigger module 210 may check for voice messages at one or more predetermined time intervals that may be pre-programmed according to instructions specified by a user.

In one embodiment, user trigger module 212 may enable a user to provide the triggering instructions to voice interacting system 100. The user may specify instructions by pressing one or more buttons on wireless terminal device 120 or otherwise indicating/specifying instructions. In another embodiment of the invention, the user may specify instructions by manipulating a touch pad (not otherwise illustrated in Figures) coupled to wireless terminal devices 120a-n. In yet another embodiment of the invention, the user may specify voice instructions to a voice recognizer (not otherwise illustrated in Figures) coupled to wireless terminal device 120.

User-specified commands that originate using digital network protocols may need to be reconfigured to a format or protocol, such as the telephone communication protocol, that is compatible with the voice mail system. In one embodiment, the voice mail system may be configured to receive instructions in Dual Tone Multi-Frequency (DTMF) format or other formats or protocols. According to the invention, the user specified commands from wireless terminal devices 120a-n may be reconfigured to the DTMF format (or other format or protocol) so as to enable voice mailbox 124 to recognize the user specified commands. Translation module 214 may interact with interface 108 and may enable reconfiguring, converting and/or translating user specified commands originating in the digital network protocols to the telephone communication protocol (such as the DTMF format or protocol, or other format or protocol).

Voice mail access module 218 may enable voice interacting system 100 to access voice messages stored in voice mailbox 124. Accessing voice messages may require the input of voice mailbox identifiers, password keys, or other access keys. In one embodiment, key input module 220 may enable voice interacting system 100 to automatically input stored voice mailbox identifiers, password keys, or other access keys so as to access one or more messages in voice mailbox 124. Certain stored voice mailbox identifiers, password keys, or other keys may be associated with a particular user. This association enables that user to access one or more particular voice mailboxes. The appropriate voice mailbox identifiers, password keys, or other keys may be utilized by key input module 220 upon recognition of one or more user identifiers. User identifiers may include, for example, an e-mail address, a wireless terminal device ID, or other identifier. In another embodiment, key input module 220 may enable users to manually input identifiers, password keys, or other keys using buttons or interface features on wireless terminal devices 120a-n.

When there is a new message in voice mailbox 124, users may be notified of the new message via wireless terminal devices 120a-n. In one embodiment of the invention, the notification operation may be performed in response to voice interacting system 100 recognizing the receipt of one or more voice messages in voice mailbox 124. In another embodiment, the notification operation may be performed a reasonable time after the receipt of a new message in voice mailbox 124.

In one embodiment, text notification module 222 may enable voice interacting system 100 to send notification of one or more new messages in text format to a user's wireless terminal device 120 utilizing a digital network protocol. In another embodiment, voice notification module 224 may enable voice interacting system 100 to send notification of one or more new messages in a voice format to a user's wireless terminal device 120 utilizing a digital network protocol.

FIG. 2B is an exemplary illustration wherein voice interacting system 100 may include, or communicate with, one or more modules (similar to or the same as modules 101a-n illustrated in FIG. 1). The one or more modules may include, for example, a retrieval module 226, an index module 228, a conversion module 230, a text view module 232, a voice recording module 234, a voice compression module 236, a voice play module 238, a voice mailbox connection module 240, or other modules.

In one embodiment, retrieval module 226 may enable voice interacting system 100 to retrieve one or more voice messages stored in voice mailbox 124. Index module 228 may en ale indexing of the voice messages retrieved from or stored: in voice mailbox 124. In one embodiment, the indexing may be text based. In another embodiment, the indexing may be voice-based. An index of the voice messages retrieved from or stored in voice mailbox 124 may be constructed using meta-data and or identification indicia (discussed in detail below) associated with the retrieved or stored voice messages. The index may then be transmitted to wireless terminal devices 120a-n and presented to the user. In one embodiment, users may select one or more of the indexed messages for transmission to wireless terminal device 120 or for retrieval and subsequent transmission. In another embodiment, users may select one or more messages that are not indexed.

In one embodiment, conversion module 230 may enable voice interacting system 100 to convert a voice message to a format compatible with wireless terminal devices 120a-n, such as, for example, short message service (SMS), MP3, global system for mobile communications (GSM), or other data communications friendly formats.

In one embodiment, text view module 232 (alone or in concert with conversion module 230) may enable users to view text versions of voice messages on wireless terminal device 120. Text view module 232 may convert a voice message to a text format, such as SMS, e-mail, and other text-based formats. The converted messages may then be sent to a wireless terminal device 120 wherein users may view the converted messages. In another embodiment of the invention, conversion module 230 may convert the voice message to other formats (e.g., MP3, GSM) that may be compatible with the wireless terminal device 120, so that the converted voice message may played on the wireless terminal devices.

Voice recording module 234 may enable voice interacting system 100 to record one or more of the retrieved voice messages in a voice format compatible with wireless terminal devices 120. Voice compression module 236 may enable voice interacting system 100 to compress one or more of the retrieved voice messages, so that the retrieved voice messages may be conveniently transmitted to and/or stored in wireless terminal devices 120. Voice playback module 238 may enable voice interacting system 100 to play a voice message recorded in the wireless terminal devices 120, so that the user may listen to the voice message via wireless terminal devices 120a-n.

According one embodiment, voice interacting system 100 may enable users to listen to the voice messages that may be stored in voice mailbox 124. Voice mailbox connection module 240 may facilitate establishing the connection from wireless terminal devices 120a-n to voice mailbox 124. Users may send commands in a data network protocol that are processed and reconfigured into a telephone communications protocol, such as DTMF touchtone instructions. These DTMF (or other) instructions may be used to retrieve one or more voice messages and/or information associated with these messages. The messages and/or associated information may then be transmitted to wireless terminal devices 120a-n.

In another embodiment, voice mailbox connection module 240 may facilitate establishing a connection from wireless terminal devices 120a-n to voice mailbox 124. In this embodiment, the connection is established by a call server (server 102 or other server) placing a call to the voice mail system, placing a second call to (or otherwise establishing a connection with) the wireless terminal device 120 (or any other telephone the user instructed the system to call), and bridging the two calls. In some embodiments, the order of the calls may be varied. After the connection is established, users may listen to the voice messages played from voice mailbox 124. The difference in protocols used by a data communications network on which the call server resides (data communications protocol) and the telephone network on which the voice mail system resides (telephone communications protocol) is bridged by voice interacting system 100. In one embodiment, this bridging is accomplished by inputting instructions into the voice mail system as telephone communications protocol based signals such as, for example DTMF signals. The bridging may also be accomplished by translating or converting voice-formatted responses from the voice mail system into a format that may be retrieved, recorded, transmitted, and or displayed on a wireless terminal device (e.g., a data communications friendly format).

As illustrated in FIG. 2C, the plurality of modules associated with voice interacting system 100 may also include, for example, a deletion module 244, a storage module 246, a reply module 248, a forwarding module 250, an identification creation module 252, a meta-data module 254, a relay module 256, and a synchronization module 258, among other modules.

In one embodiment, deletion module 244 may enable users to delete voice messages (e.g., voice messages stored in voice mailbox 124) using wireless terminal devices 120, among other devices. Additionally, storage module 246 may enable users to save voice messages (e.g., voice messages stored in voice mailbox 124) in wireless terminal devices 120a-n, message database 122, or in other areas.

In one embodiment, reply module 248 may enable users to reply to one or more messages including voice messages that are stored in wireless terminal device 120, voice messages that are retrieved from voice mailbox 124, voice messages that are stored in voice mailbox 124, translated messages that are in a text format, and voice or text messages that are stored in message database 122, or other messages. In one embodiment, users of wireless terminal devices 120 may reply by voice (e.g., by talking through a personal digital assistant). In another embodiment of the invention, users of wireless terminal devices 120 may reply by entering text (e.g., by typing using text-based wireless terminal device). In one embodiment of the invention, users of wireless terminal devices 120 may send a voice reply to a telephone 130 and/or another wireless terminal device 120. In another embodiment of the invention, users of wireless terminal devices 120 may send a voice reply or a text reply to an e-mail account, to another wireless terminal device, to a website, or to another location.

In one embodiment, forwarding module 250 may enable users to forward one or more messages to other users including voice messages that are recorded in wireless terminal devices 120, voice messages that are retrieved from voice mailbox 124, voice messages that are stored in voice mailbox 124, translated messages that are stored in a text format, and voice or text messages that are stored in message database 122, among other messages. In one embodiment, users of wireless terminal device 120 may forward voice messages to a telephone 130. In another embodiment of the invention, users of wireless terminal devices 120 may forward voice messages or translated text messages to an e-mail account, to another wireless terminal device, to a website, or to another destination.

According to another aspect, the invention provides features and functions for creating meta-data for voice messages in voice mailbox 124. When new voice messages are recognized in voice mailbox 124, meta-data module 254 may create one or more voice signatures or voice meta-data by extracting data associated with a predetermined portion of the voice message (e.g., data associated with the first few seconds of the voice message). In one embodiment of the invention, voice meta-data may be converted and/or stored as textual data. Metadata module 254 may create other meta-data associated with messages from voice mailbox 124 such as, for example, caller ID information, length of the message, date of receipt of message, time of receipt of message, or other metadata.

When users of text based wireless terminal device 120 take action (e.g., forward, reply) on selected voice messages, meta-data module 254 may create additional meta-data (e.g., voice or text) that may include a description in the message of the action taken (e.g., forward, reply).

According to another aspect of the invention, ID creation module 252 may create identification indicia (e.g., alphanumeric identification numbers) that identify voice messages in the voice mailbox 124 (or on voice interacting system 100). In one embodiment of the invention, the identification indicia may include or otherwise be linked to meta-data associated with the individual voice messages. This identification indicia may include, for example, data associated with a predetermined portion of a voice message (e.g., data associated with the first few seconds of the voice message), caller ID, the length of the message, the date of receipt of the message, the time of receipt of the message, or other identification indicia. In one embodiment, relay module 256 may relay the meta-data and/or the identification indicia for the voice message to message database 122.

When a new message or an update of an existing message is received in voice mailbox 124, the new message or the updated message may be replicated in message database 122. Synchronization module 258 may facilitate the replication of messages to message database 122 or synchronize the messages between voice mailbox 124 and message database 122. In one embodiment of the invention, a map may be created between messages stored in voice mailbox 124 and the corresponding messages (i.e., the replicated message) stored in message database 122. In one embodiment, synchronization module 258 may utilize identification indicia to perform and track synchronization.

The invention may also include other message related modules and/or functionalities that would be apparent to one skilled in the art.

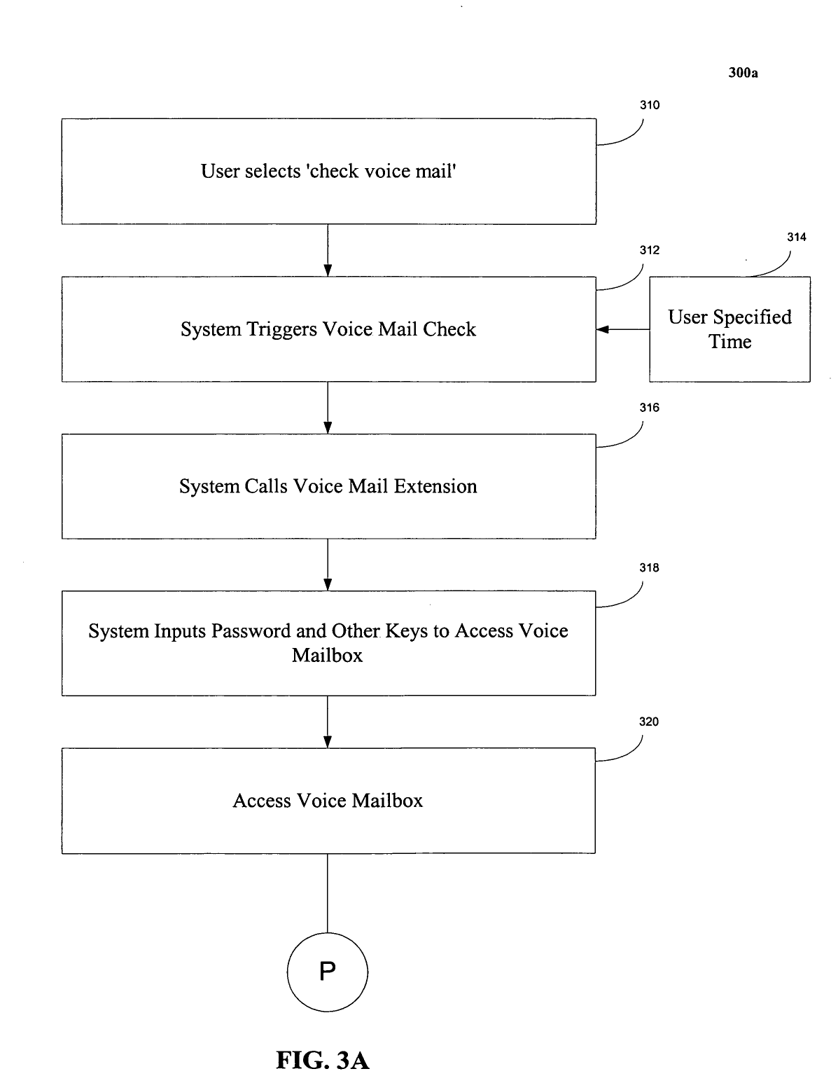

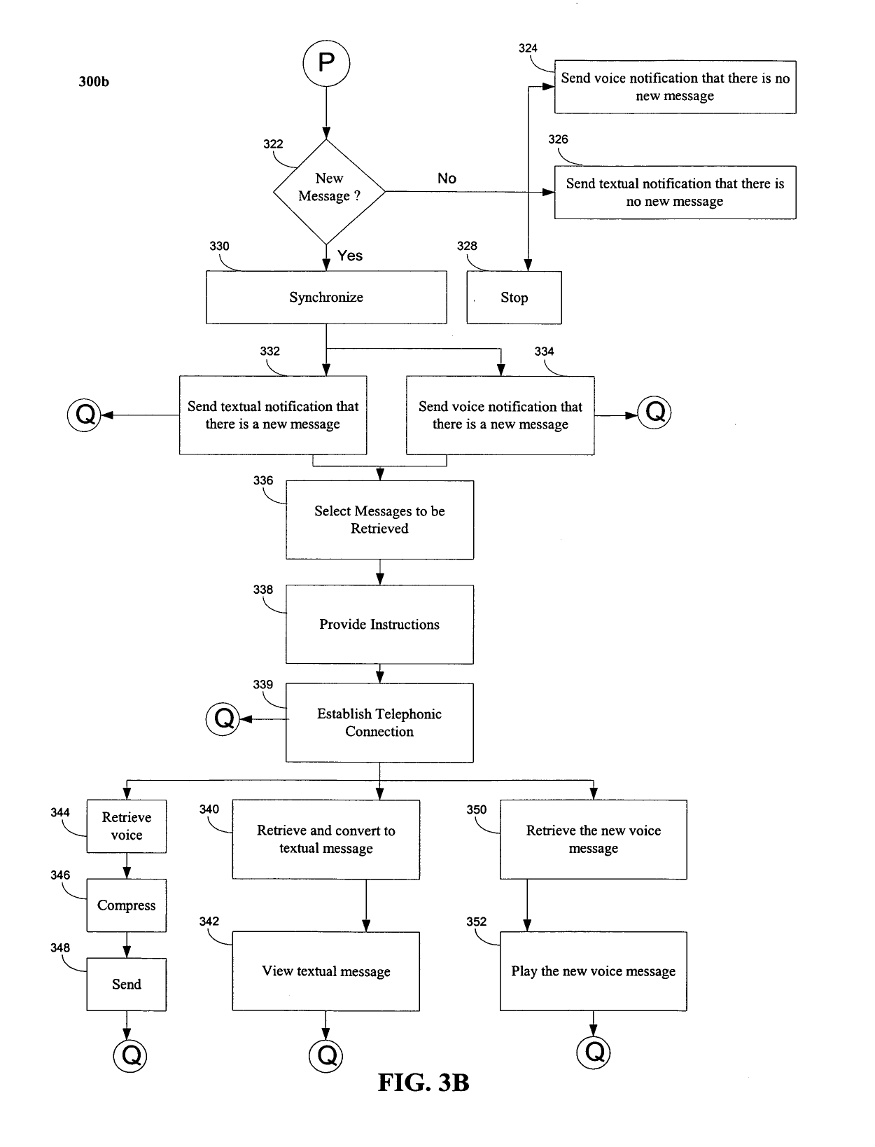

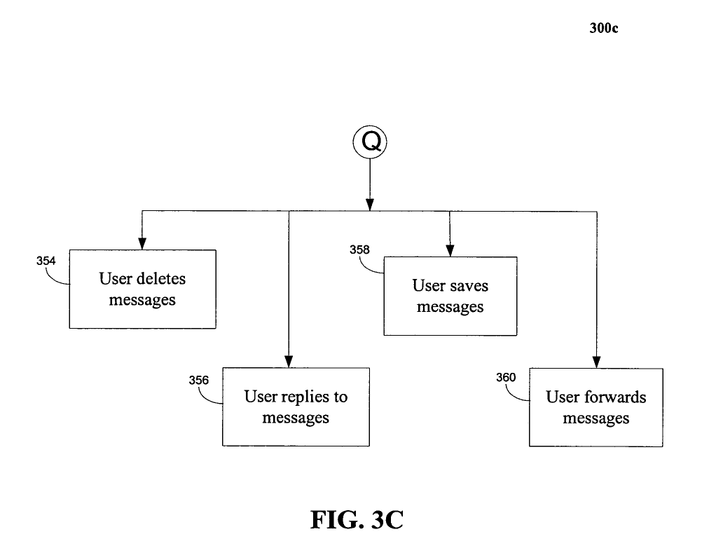

FIG. 3A is an exemplary illustration of a method 300a according to an embodiment of the invention, wherein users may access voice messages in voice mailbox 124 using wireless terminal devices 120a-n. In an operation 310, users may select an option in a wireless terminal device 120 to ‘check voice mail.’ In response to the user selecting a ‘check voice mail’ (or similar option) wireless terminal device 120 may send a command to voice interacting system 100. The voice interacting system 100 may then automatically trigger or initiate the voice mail check process in an operation 312. In one embodiment of the invention, in an operation 314, the initiation of voice mail check process may be alternatively triggered upon the occurrence of a predetermined event such as, for example recognizing receipt of a new voice message or passage of a pre-determined time interval. Other events or methods may trigger initiation of a voice mail check.

In an operation 316, voice interacting system 100 may establish telephonic connection from the data communication network to the voice mail system by calling a voice mail extension, an access number for the voice mailbox 124, or otherwise connecting to voice mail server 125. In one embodiment call server 102 may initiate a telephone call to voice mail server 125 to establish such a telephonic connection. In an operation 318, voice interacting system 100 may input a voice mailbox ID, a password, and/or provide other keys to access voice messages stored in voice mailbox 124. The inputted mailbox ID, password and/or other keys may be reconfigured, converted, or translated from a digital network protocol to a telephone communications protocol, such as DTMF format or protocol, or other formats or protocols, to enable voice mailbox 124 to recognize the inputted password or keys. In one embodiment of the invention, voice interacting system 100 may store the voice mailbox ID, passwords, and/or the other keys. Mailbox IDs, passwords, and other keys for individual mailboxes may be associated with their particular users and/or the one or more wireless terminal devices with which they are associated.

In another embodiment of the invention, users may be prompted to manually input one or more of a mailbox ID, password, and/or other keys. Users may input the password and/or enter the other keys by pressing a plurality of buttons or interface features on wireless terminal devices 120a-n. In one embodiment, this information may then be sent from the wireless terminal device to voice interacting device 100 through any data connection such as, for example, a direct HTTP connection, an e-mail message, or other connection. The inputted mailbox ID, password and/or other keys may be reconfigured, converted, or translated from a digital network protocol to a telephone communications protocol, such as DTMF format or protocol, or other formats or protocols, to enable the voice mail system (e.g., voice mail server 125) to recognize the inputted password or keys. In operation 320, voice interacting system 100 may access voice messages stored in voice mailbox 124.

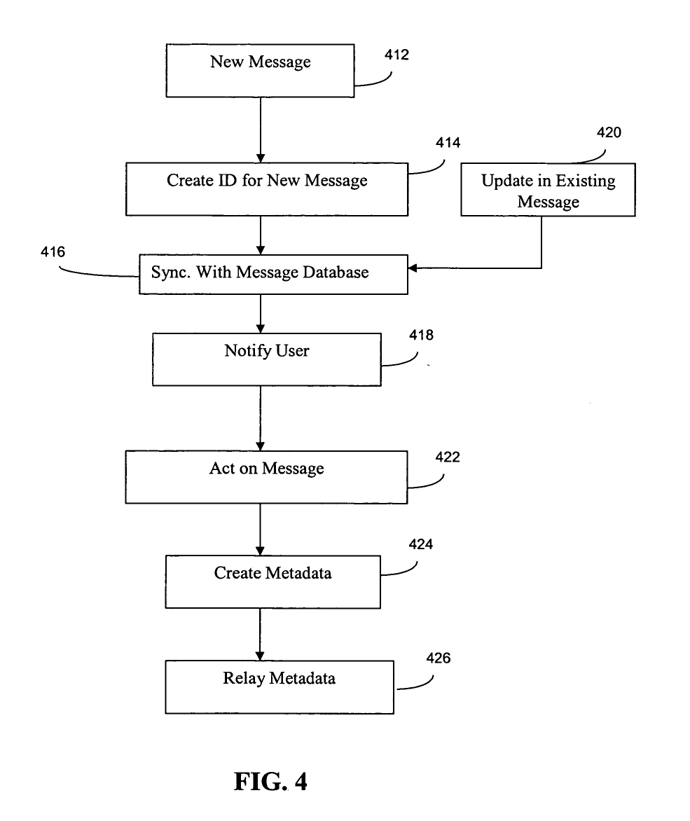

FIG. 3B illustrates an exemplary process 300b, wherein voice interacting system 100 may enable user interaction with voice mailbox 124. In an operation 322, voice interacting system 110 may determine whether there are one or more new messages present in voice mailbox 124. In one embodiment, voice interacting system 100 may also determine whether any updates were made to any of the existing messages in voice mailbox 124. If new messages or updates are present in the voice mailbox 124, voice interacting system 100 may enable synchronization with message database 122 in an operation 330. In some embodiments, message database 122 may also be synchronized with wireless terminal devices 120a-n. In one embodiment, synchronization may include voice interacting system 100 replicating the voice messages within voice mailbox 124 (new, old, updated, or other messages) and storing the replicated messages in message database 122 (to the extent that they are not already stored therein). Synchronization is discussed in detail below in FIG. 4.

If, in an operation 322, it is determined that there are no new messages or no updated messages in voice mailbox 124, the voice mail check process may stop in an operation 328. In one embodiment of the invention, upon determining that there are no new or updated messages, voice interacting system 100 may, in an operation 324, send voice notification to wireless terminal devices 120a-n that there are no new messages. In another embodiment of the invention, upon determining that there are no new or updated messages, voice interacting system 100 may, in an operation 326, send textual notification to wireless terminal devices 120a-n that there are no new messages.

If, in an operation 322, it is determined that there are one or more new messages in voice mailbox 124, voice interacting system 100 may send a notification to wireless terminal devices 120a-n. In an operation 332, voice interacting system 100 may send a textual notification to wireless terminal device 120a-n that there are new messages in voice mailbox 124. In one embodiment of the invention, the notification may be formatted to include meta-data such as, for example, textual headings (e.g., textual format of first few words of voice message), subject matter, caller ID, or other information. In an operation 334, voice interacting system 100 may send voice notifications to wireless terminal devices 120a-n indicating that there are new messages. Voice notification may also include providing meta data in a voice format.

In an operation 336, users may select one or more of the new messages for retrieval from voice mailbox 124. In one embodiment of the invention, users may select from one or more messages that are displayed in an index of messages in voice mailbox 124. In one embodiment, the index may be created from the meta-data associated with each of the messages. The index may then be displayed on a wireless terminal device 120.

In operation 338, users may provide instructions to retrieve the messages from voice mailbox 124. The instructions may include, for example, the format in which a user wants to receive the retrieved messages (e.g., text, MP3, etc.) In an alternative embodiment of the invention, the system may automatically retrieve the accessed messages in voice mailbox 124 and/or may automatically retrieve and convert the accessed messages in voice mailbox 124 to textual messages.

In one embodiment of the invention, after the users select the voice messages for retrieval and/or provide instructions for retrieval, voice interacting system 100 may, in an operation 339, establish a telephonic connection (e.g., according to telephone communications format or protocol) with voice mail server 125 to enable the users to access and interact with the selected voice messages within voice mailbox 124. This telephonic connection may be the same telephonic connection as mentioned above for determining whether new messages exist, or may be a separate or subsequent telephonic connection. For the systems and methods described herein, multiple and/or successive telephonic, data communication, or other connections may be utilized to enable to functionalities of the invention.

In an operation 340, messages may be retrieved from voice mailbox 124 and converted or translated to a textual format, or other format. This conversion of voice formatted messages to text format may be accomplished by voice recognition systems known to those skilled in the art. In an operation 342, users may view the voice messages in textual format on the wireless terminal device 120.

In another embodiment of the invention, the retrieved voice messages may be retrieved in an operation 344 and compressed in operation 346. The voice messages in the compressed format may be sent to wireless terminal devices 120a-n in an operation 348.

In yet another embodiment of the invention, the voice messages may be retrieved in an operation 350. In an operation 352, the retrieved voice messages may be played on a user's wireless terminal device 120.

Voice interacting system 100 may utilize DTMF or other telephone communication formats or protocols to communicate via a telephonic connection with voice mail server 125 for the purpose of accessing, selecting, and or manipulating one or more voice messages within voice mailbox 124 (or for other purposes). As mentioned above, voice interacting system 100 may utilize voice recognition software, recording software, and/or other conversion software or modules (some of which may be the same as or similar to the software modules described in FIGS. 2A through 2C above) for retrieval, forwarding, transmitting or other handling of voice messages from voice mailbox 124.

The points illustrated in FIG. 3B by an arrow pointing to a “Q” indicate points within a process of the invention at which some or all of the operations or functions of process 300c described below in FIG. 3C, may be performed. In alternative embodiments, the operations or functions of FIGS. 3A through 3C may be performed in various orders.

FIG. 3C illustrates an exemplary process 300c according to an embodiment of the invention wherein voice interacting system 100 may enable users to perform a plurality of functions on the voice messages. In one embodiment of the invention, users may perform these functions by providing instructions to wireless terminal devices 120a-n (e.g, by talking into to, selecting buttons from, or otherwise providing instructions to wireless terminal devices 120a-n). Operations 354-360 illustrate some of the actions that may be carried out according to user instructions. In an operation 354, users may delete one or more voice messages. In an operation 356, users may send a reply for one or more voice messages. In one embodiment, users may send a reply to a telephone, voice mailbox, or to another wireless terminal device. In another embodiment, users may send a reply to an e-mail address, a website, or other destination.

In operation 358, users may save one or more messages in wireless terminal device 120. In one embodiment of the invention, users may save one or more messages in message database 122, wireless terminal device 120, or other location. In operation 360, users may forward one or more messages to another user. In one embodiment of the invention, users may forward one or more messages to a telephone, voice mailbox or another wireless terminal device. In another embodiment of the invention, users may forward one or more messages to an e-mail address, a website, or other destination.

FIG. 4 illustrates a process of synchronizing messages between voice mailbox 124 and message database 122. In an operation 412, new messages in voice mailbox 124 may be recognized by voice interacting system 100. In an operation 414, identification indicia (e.g., alphanumeric identifiers) may be created for the new messages. In one embodiment of the invention, the identification indicia may include or otherwise be linked to meta-data such as, for example, data associated with a predetermined portion of the voice message (e.g., data associated with the first few seconds of the voice message), caller ID, length of the message, date of receipt of the message, time of receipt of the message, and/or other metadata.

In an operation 416, voice interacting system 100 may facilitate synchronization with message database 122 or other storage unit within the system of the invention. In one embodiment of the invention, when identification indicia is created corresponding to new messages, voice interacting system 100 may replicate the new messages and its identification indicia to message database 122 or a storage unit within wireless terminal devices 120.

In an operation 420, an update in one or more of the existing messages in voice mailbox 124 may be recognized by voice interacting system 100. The updated messages may be synchronized with message database 122 or a storage unit within wireless terminal device 120 in operation 420. In an operation 418, the system may notify users upon recognition of new messages or updated messages through the wireless terminal device 120.

In an operation 422, users of the wireless terminal devices 120a-n may take action (e.g., forward, reply) upon receipt of voice messages. In an operation 424, voice interacting system 100 may create meta-data (e.g., voice or text) that may include a description of the action taken (e.g., forward, reply) on the messages. In one embodiment of the invention, when a new voice message is recognized in the voice mailbox, a voice signature or a voice meta-data may be created by extracting data associated with a predetermined portion of the voice message (e.g., data associated with a first few seconds of the voice message). In one embodiment of the invention, voice meta-data may be converted and stored as a textual data.

In an operation 426, meta-data, including the user's action taken on the voice message and the identification indicia for the voice message, may be relayed to message database 122 of voice interacting system 100.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method for retrieving voice mail from a voice mail system via a wireless terminal device, wherein the wireless terminal device is operating in a data communications network, and wherein the data communications network is unassociated with the voice mail system, the method comprising:
establishing a connection from the data communications network to the voice mail system;
determining whether one or more new messages exist in a voice mailbox within the voice mail system via the established connection;
sending a notification to a wireless terminal device operating in the data communications network regarding the one or more new messages;
receiving instructions from the wireless terminal device to retrieve at least one of the one or more new messages from the voice mailbox;
retrieving the at least one of the one or more new messages from the voice mailbox via the telephonic connection; and
sending information regarding the one or more new messages to the wireless terminal device.

2. The method of claim 1, wherein establishing a connection comprises establishing a telephonic connection.

3. The method of claim 1, wherein the voice mail system comprises an enterprise voice mail system.

4. The method of claim 1, wherein at least one of the one or more new messages include updated messages.

5. The method of claim 1, wherein establishing a connection further comprises:
receiving a trigger to check for one or more new messages in the voice mailbox wherein the trigger is one or more of a user initiated trigger, an occurrence of a predetermined event, or passage of a predetermined time interval; and
initiating a telephone call from the data communications network to the voice mail system.

6. The method of claim 3, wherein establishing a telephonic connection further comprises inputting one or more access keys into the voice mail system to access the user mailbox.

7. The method of claim 6, wherein inputting one or more access keys further comprises inputting Dual Tone Multi-Frequency signals into the voice mail system.

8. The method of claim 1, wherein determining whether one or more new messages exist further comprises:
receiving voice-formatted information from the voice mail system regarding the presence or absence of one or more new messages in the voice mailbox;
translating the voice formatted information into a data communication friendly format; and
discerning from the translated information whether one or more new messages exist in the voice mailbox.

9. The method of claim 1, wherein retrieving the at least one of the one or more new messages from the voice mailbox further comprises creating one or more pieces of meta-data for each of the one or more new messages.

10. The method of claim 9, wherein the one or more pieces of metadata include at least one of a voice signature, caller identification information, date of receipt of the message, time of receipt of the message, or an identification number associated with the message.

11. The method of claim 9, wherein retrieving the at least one of the one or more new messages from the voice mailbox further comprises creating an index of the one or more new messages utilizing at least one of the one or more pieces of meta-data; and wherein sending information regarding the at least one of the one or more new messages to the wireless terminal device includes sending the index to the wireless terminal device.

12. The method of claim 1, wherein retrieving the at least one of the one or more new messages from the voice mailbox further comprises establishing a second telephonic connection from the data communications network to the voice mail system.

13. The method of claim 1, wherein retrieving the at least one of the one or more new messages from the voice mailbox further comprises receiving the at least one of the one or more new messages in voice format from the voice mail system and storing the at least one of the one or more new messages in a database.

14. The method of claim 13, further comprising synchronizing the message database with the voice mailbox.

15. The method of claim 13, wherein sending information regarding the one or more new messages further comprises compressing the at least one of the one or more new messages and sending the at least one compressed new message to the wireless terminal device.

16. The method of claim 13, wherein sending information regarding the one or more new messages further comprises converting at least part of the at least one of the one or more new messages to text format and sending the at least one new text message to the wireless terminal device.

17. The method of claim 1, further comprising:
receiving an instruction from the wireless terminal device regarding an action to be taken on the at least one of the one or more new messages; and
performing at least one action on the at least one of the one or more new messages.

18. The method of claim 17, wherein the at least one action includes one or more of deleting the at least one new message, replying to the at least one new message, saving the at least one new message, marking the at least one new message as read, marking the at least one new message as new, or forwarding the at least one new message.

19. A computer-implemented method for interacting with a voice mailbox on an unassociated voice mail system via a wireless terminal device, wherein the wireless terminal device is operating in a data communications network, and wherein the data communications network is not part of the voice mail system, the method comprising:
establishing a connection from the data communications network to the unassociated voice mail system;
accessing the voice mailbox via the established connection;
receiving instructions from the wireless terminal device to retrieve at least one of the one or more messages from the voice mailbox;
retrieving the at least one of the one or more messages from the voice mailbox via the telephonic connection; and
sending information regarding the one or more messages to the wireless terminal device.

20. A computer-implemented system for retrieving voice mail from a voice mail system via a wireless terminal device, wherein the wireless terminal device is operating in a data communications network, and wherein the data communications network is unassociated with the voice mail system, the system comprising:
means for establishing a connection from the data communications network to the voice mail system;
means for determining whether one or more new messages exist in a voice mailbox within the voice mail system via the established connection;
means for sending a notification to a wireless terminal device operating in the data communications network regarding the one or more new messages;
means for receiving instructions from the wireless terminal device to retrieve at least one of the one or more new messages from the voice mailbox;
means for retrieving the at least one of the one or more new messages from the voice mailbox via the telephonic connection; and
means for sending information regarding the one or more new messages to the wireless terminal device.

21. The system of claim 20, wherein the connection comprises a telephonic connection.

22. The system of claim 20 wherein the voice mail system comprises an enterprise voicemail system.

23. The system of claim 20, wherein at least one of the one or more new messages include updated messages.

24. The system of claim 20, wherein the means for establishing a connection further comprises:
means for receiving a trigger to check for one or more new messages in the voice mailbox wherein the trigger is one or more of a user initiated trigger, an occurrence of a predetermined event, or passage of a predetermined time interval; and
means for initiating a telephone call from the data communications network to the voice mail system.

25. The system of claim 24, wherein the means for establishing a telephonic connection further comprises means for inputting one or more access keys into the voice mail system to access the user mailbox.

26. The system of claim 25, wherein the means for inputting one or more access keys further comprises means for inputting Dual Tone Multi-Frequency signals into the voice mail system.

27. The system of claim 20, wherein the means for determining whether one or more new messages exist further comprises:
means for receiving voice-formatted information from the voice mail system regarding the presence or absence of one or more new messages in the voice mailbox;
means for translating the voice formatted information into computer-readable format; and
means for discerning from the translated information whether one or more new messages exist in the voice mailbox.

28. The system of claim 20, wherein the means for retrieving the at least one of the one or more new messages from the voice mailbox further comprises means for creating one or more pieces of meta-data for each of the one or more new messages.

29. The system of claim 28, wherein the one or more pieces of metadata include at least one of a voice signature, caller identification information, date of receipt of the message, time of receipt of the message, or an identification number associated with the message.

30. The system of claim 28, wherein the means for retrieving the at least one of the one or more new messages from the voice mailbox further comprises means for creating an index of the one or more new messages utilizing at least one of the one or more pieces of meta-data; and wherein the means for sending information regarding the at least one of the one or more new messages to the wireless terminal device includes means for sending the index to the wireless terminal device.

31. The system of claim 20, wherein the means for retrieving the at least one of the one or more new messages from the voice mailbox further comprises means for establishing a second telephonic connection from the data communications network to the voice mail system.

32. The system of claim 20, wherein the means for retrieving the at least one of the one or more new messages from the voice mailbox further comprises means for receiving the at least one of the one or more new messages in voice format from the voice mail system and means for storing the at least one of the one or more new messages in a database.

33. The system of claim 32, further comprising means for synchronizing the message database with the voice mailbox.

34. The system of claim 32, wherein the means for sending information regarding the one or more new messages further comprises means for compressing the at least one of the one or more new messages and means for sending the at least one compressed new message to the wireless terminal device.

35. The system of claim 32, wherein the means for sending information regarding the one or more new messages further comprises means for converting at least part of the at least one of the one or more new messages to text format and means for sending the at least one new text message to the wireless terminal device.

36. The system of claim 20, further comprising:
means for receiving an instruction from the wireless terminal device regarding an action to be taken on the at least one of the one or more new messages; and
means for performing at least one action on the at least one of the one or more new messages.

37. The system of claim 36, wherein the at least one action includes one or more of deleting the at least one new message, replying to the at least one new message, saving the at least one new message, marking the at least one new message as read, marking the at least one new message as new, or forwarding the at least one new message.
